(19) United States
(12) Patent Application Publication
(10) Pub. No.: US 2019/0118359 A1
(43) Pub. Date: Apr. 25, 2019

(54) ADAPTOR AND METHOD FOR MOTORIZED OPERATION OF A SPRING COMPRESSOR

(71) Applicant: Larry Verbowski, Bay City, MI (US)

(72) Inventor: Larry Verbowski, Bay City, MI (US)

(21) Appl. No.: 15/787,761

(22) Filed: Oct. 19, 2017

(51) Int. Cl. B25B 27/30

(52) U.S. Cl. CPC B25B 27/304; B60G 2206/921

(57) ABSTRACT

A mechanical adaptor to enable the motorization of an otherwise non-motorized strut compressor for use in assembling and disassembling a strut assembly of the type having a shock absorber axially disposed within a coil spring. The adaptor when used in combination with an electric pipe threader and an otherwise non-motorized strut compressor enables a method for the motorized compression and release of strut springs using the otherwise non-motorized strut compressor.

### BACKGROUND OF THE INVENTION

This invention deals with mechanical adaptors and methods of their use as well as combinations comprising these adaptors to enable the motorization of otherwise manual spring compressors using a motorized unit of an electric pipe threader.

Manual hand-turn spring compressors, such as strut spring compressors sold under the brand name BRANICK® Fargo, N.D., are used in assembling and disassembling strut assemblies having a shock absorber axially disposed within a coil spring. Operation of these spring compressors requires high levels of physical exertion on the part of an operator to overcome resistance to compression by strut springs. Such physical exertion can lead to operator injury. The present invention enabling a motorized operation of a spring compressor obviates this potential for injury.

What's more, strut spring compressors, particularly those manufactured under the brand name BRANICK, are difficult to properly position for optimal safety and convenience to a user. For example, if the manual turning mechanism for operating the compressor is lowered to the ground to facilitate operator accessibility the unit functionality is compromised because a strut assembly can then not be readily loaded into the machine, which much be done from the bottom, due to the proximity of the bottom of the device to the floor. Also, if the strut compressor is oriented vertically at an appropriate height for proper loading and unloading of a strut assembly it becomes difficult for an operator then to reach the manual turning mechanism, thereby increasing potential for injury and fatigue. The present invention overcomes this difficulty by removing the need for a user to manually lower a threaded shaft of a spring compressor in order to compress a spring.

Additionally, due to the physical forces required and the above described difficulties in operation presented by the design of some strut spring compressors, it takes an extended period of time for an operator to manually compress a strut spring by their use. The present invention by enabling the motorized operation of an otherwise non-motorized strut compressor removes variables potentially detrimental to optimal operation of a spring compressor including, among other variables, operator fatigue, operator limitations in physical strength, and operator limitations in skill, thereby substantially increasing the speed, efficiency, and consistency of operation with which a spring may be compressed.

Prior art relating to the present invention and known to the inventor herein include U.S. Pat. No. 7,386,926 B2, issued to Kevin S. Bosche et al. on Jun. 17, 2008, U.S. Pat. No. 7,680,686 issued to Kevin S. Bosche et al. on Oct. 28, 1997 and U.S. Pat. No. 4,785,519 issued to Harold Krueger et al. on Nov. 22, 1988. All three of these patents disclose a manually operated (ie. non-motorized) apparatus for use in assembling and disassembling a strut assembly of the type having a shock absorber axially disposed within a coil spring.

U.S. Pat. No. 4,502,664 issued to Roy B. Bendickson, et al. on Mar. 5, 1985 discloses a MacPherson strut spring compressor having a drive mechanism to move a strut clamp assembly. There is no mention in this patent of motorization and no mention of the use of an electric pipe threader, as in the present invention.

The following three U.S. patents disclose coil spring compressors adapted for use in the assembly of automotive suspension systems: U.S. Pat. No. 4,486,935 issued to Hiroo Kashiwagi et al. on Dec. 11, 1984; U.S. Pat. No. 4,494,289 issued to Tsuyoshi Matsuura on Jan. 22, 1985; U.S. Pat. No. 4,520,543 issued to Yuji Ito on Jun. 4, 1985. These coil spring compressors utilize an electric motor as a means of raising and lowering a threaded shaft to compress a spring.

None of the above referenced patents disclose a device or a method of use thereof enabling the motorization of an otherwise manually operated spring compressor. Moreover, none of the above referenced patents disclose the combination of a mechanical adaptor with an electric pipe threader and an otherwise non-motorized spring compressor nor do they disclose a method of using this combination to compress a spring, as in the present invention.

### THE INVENTION

Thus, what is disclosed and claimed herein is a mechanical adaptor for compressing springs with a strut spring compressor using a portable electric pipe threader motor assembly. The mechanical adaptor is comprised of a metal unitary hub having a top, a bottom, and a vertical centered axis. The top portion has an outside surface configured to fit a die holder of a motorized unit of a portable electric pipe threader. The top portion also has an opening passing through the centered vertical axis. The bottom portion has an opening aligned with the opening in the top portion. The bottom portion has an appropriate means to be mounted onto an upper hub of the strut compressor.

Another embodiment of the invention is a motorized strut compressor comprising in combination, first, a non-motorized strut compressor. To this is added the mechanical adaptor described supra rigidly mounted to the upper hub of the strut compressor. Finally, a motorized unit of a portable electric pipe threader is rigidly mounted to the strut compressor by an anti-rotation stem and rigidly secured to the mechanical adaptor by a die holder of the pipe threader.

A further embodiment of the invention is a method of compressing a spring. The method involves first providing the motorized strut compressor described supra. A spring is then installed into the compressor. Then the spring is compressed by operating the electric pipe threader to turn the mechanical adaptor so as to lower a threaded shaft of the strut compressor. Finally, the spring is released by reversing the electric pipe threader to turn the mounted adaptor to raise the threaded shaft of the spring compressor.

Another embodiment of the invention is a motorized strut spring compressor comprising in combination a motorized unit of a portable electric pipe threader and a non-motorized strut spring compressor. The electric pipe threader is rigidly mounted to the spring compressor by an anti-rotation stem and also rigidly mounted to an upper hub of the spring compressor by a die holder of the electric pipe threader. The upper hub has an appropriate shape to allow the motorized unit to mount to it by the die holder of the motorized unit.

Another embodiment of the invention is a method of compressing a spring using the device described immediately supra. A spring is installed into the motorized strut spring compressor and then compressed by operating the electric pipe threader to turn the upper hub of the strut spring compressor and lower a threaded shaft of the strut compressor. The spring is then released by reversing the electric pipe threader to turn the rigidly mounted adaptor to raise the threaded shaft of the strut compressor.

### BRIEF DESCRIPTION OF THE DRAWINGS

FIG. 1 is an elevation view showing an adaptor for motorized operation of a spring compressor in combination with a spring compressor and an electric pipe fitter compressing a strut spring.

FIG. 2 is a full side view of an adaptor for motorized operation of a spring compressor.

FIG. 3 is a full top view of an adaptor for motorized operation of a spring compressor wherein the adaptor has openings (in phantom) along the perimeter as means for rigid mounting to an upper hub of a spring compressor.

FIG. 4 is a full side view of an adaptor for motorized operation of a spring compressor wherein the adaptor has slotted means for rigid mounting to an upper hub of a spring compressor.

FIG. 5 is a side cross-sectional view of a portion of an adaptor for motorized operation of a spring compressor rigidly mounted to an upper hub of the spring compressor wherein the adaptor has openings along the perimeter as means for rigid mounting to an upper hub of a spring compressor.

FIG. 6 is a partial exploded view of an adaptor for motorized operation of a spring compressor shown in combination with an electric pipe threader and an upper hub of a spring compressor wherein the adaptor has openings along the perimeter as means for rigid mounting to an upper hub of a spring compressor.

### DETAILED DESCRIPTION OF THE INVENTION

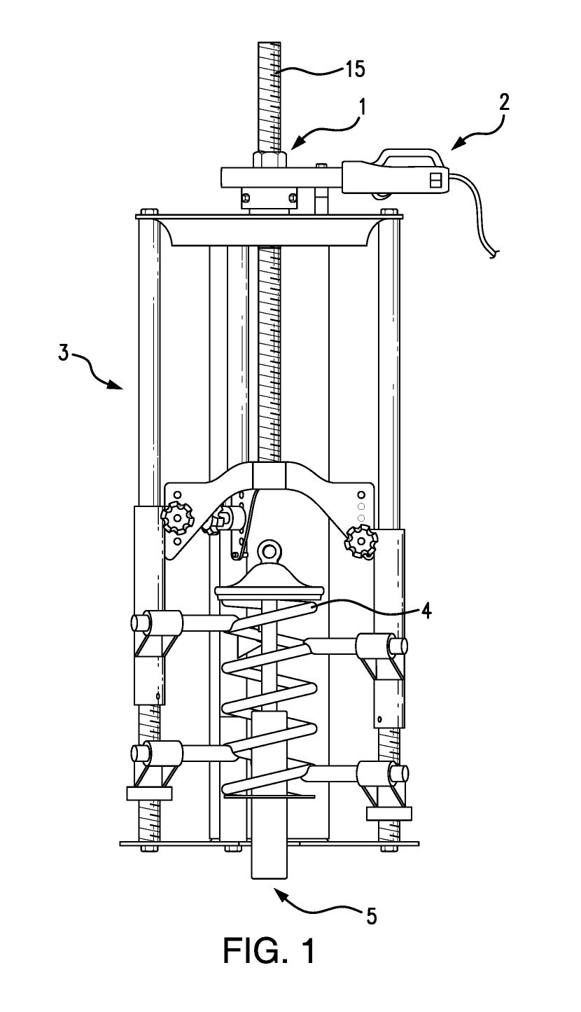

FIG. 1 is an elevation view of the adaptor 1 for enabling the motorized compression of springs 4 using an otherwise non-motorized strut spring compressor 3 in combination with an otherwise non-motorized strut compressor 3 and a portable electric pipe threader motor assembly 2. A representative spring compressor 3 with which the adaptor 1 may be used in combination is a strut spring compressor 3 manufactured by BRANICK. A representative electric pipe threader 2 motor assembly with which the adaptor 1 may be used in combination is a portable electric pipe threader 2 manufactured by CENTRAL MACHINERY® Camarillo, Calif.

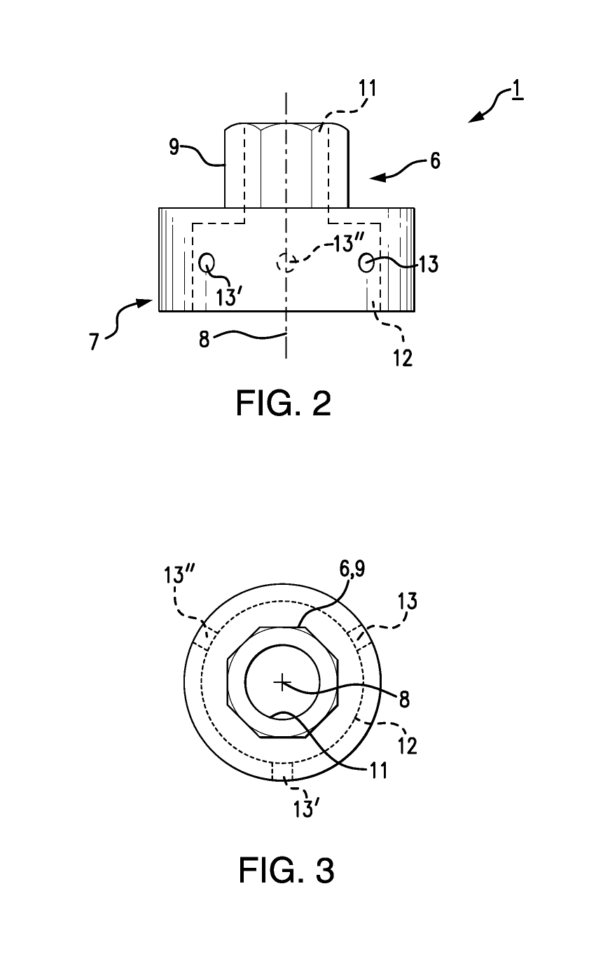

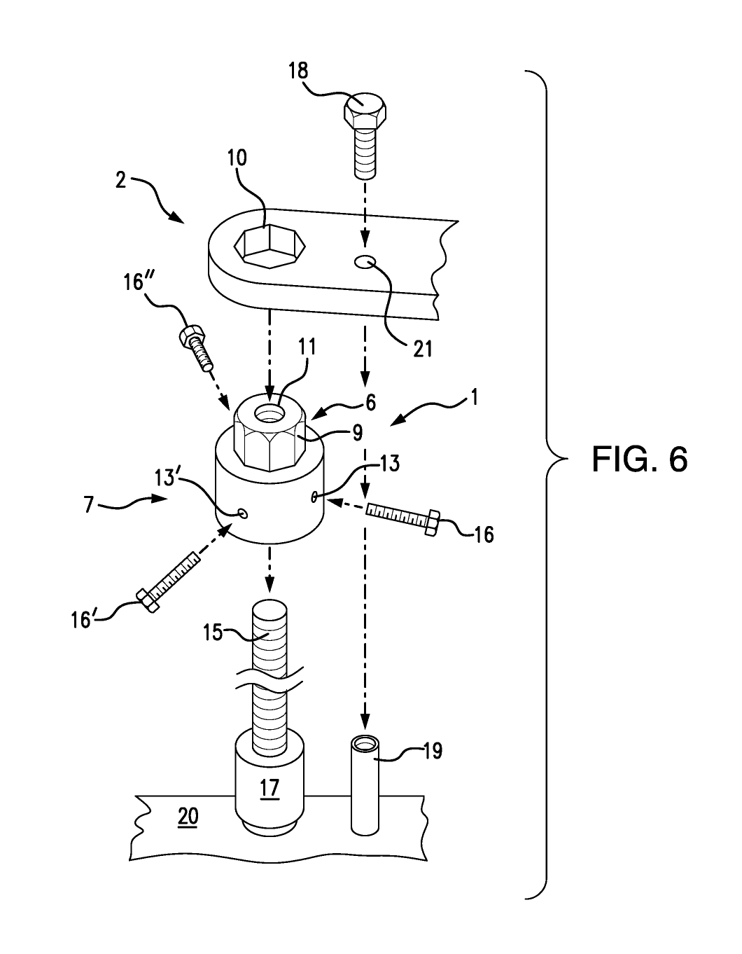

FIGS. 2 and 3 show full side and top views of the adaptor 1, respectively. The adaptor 1 is a metal unitary hub with a top portion 6, a bottom portion 7, and a vertical centered axis 8 through both portions. FIGS. 3 and 6 show the top portion 6 with an outside surface 9 configured to fit a die holder 10 of a motorized unit of an electric pipe threader 2.

An electric pipe threader 2 is used to thread pipes (not shown) of different diameters. This is accomplished through the use of different sized threading dies (not shown), which are rigidly mounted to the motorized unit of an electric pipe threader 2 via its die holder 10. These threading dies are shaped along their perimeter so as to rigidly mount within the die holder 10 of an electric pipe threader. In the present embodiment of the invention, the top portion 6 of the adapter 1 is so shaped along its perimeter 9 and with a sufficient depth as to rigidly mount within the die holder 10 of a motorized unit of an electric pipe threader 2 in a manner similar to a die normally used with the pipe threader 2 for threading pipes. In the embodiment shown in FIGS. 3 and 6 the appropriate shape to accommodate the die holder 10 of an electric pipe threader 2 is octagonal, but other shapes or depths may be necessary to accommodate different pipe threaders used in a particular application.

FIG. 5 shows top portion 6 of the adaptor 1 having an opening 11 through its centered vertical axis 8 of appropriate dimensions to accommodate the threaded shaft 15 of a strut compressor 3.

The bottom portion 7 of the adaptor 1 has an opening 12 aligned with the top portion opening 11. FIG. 5 shows this opening being of appropriate dimensions to accommodate an upper hub 17 of a spring compressor 3 in an installed configuration.

The bottom portion 7 of the adaptor 1 has means to be rigidly mounted to an upper hub 17 of a spring compressor 3. FIGS. 1, 2, 3 and 6 show this means in the form of openings 13 along the perimeter of the bottom portion 7. In the embodiment shown in these figures, there are three openings 13 along the perimeter of the adaptor 1 so positioned as to align with threaded openings 22 in the top of an upper hub 17 of a spring compressor 3 originally used to secure bars (not shown) used by an operator to manually turn the upper hub 17. The adaptor 1 may be rigidly secured by means of bolts 16 fed through the openings 13 in the bottom portion 7 of the adaptor 1 and tightly secured to an upper hub 17 of a strut compressor 3 by means of its threaded holes 22.

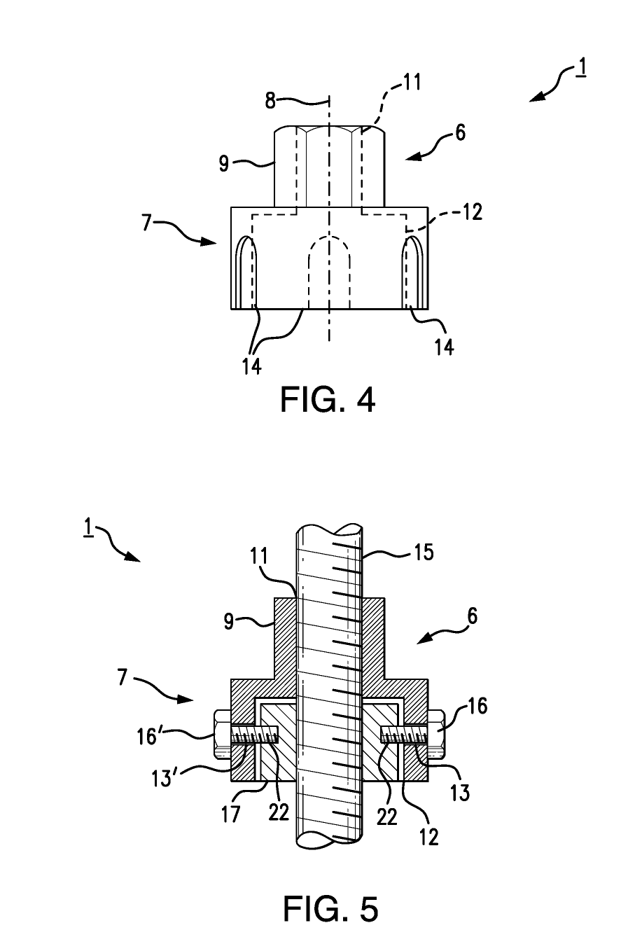

FIG. 4 shows an additional embodiment of the adaptor 1 wherein means to be rigidly mounted to an upper hub 17 is through the use of vertical slots 14 along the surface of its bottom portion 7. These vertical slots may be used to rigidly mount the adaptor 1 to an upper hub 17 of a spring compressor 3 in a manner similar to the openings 13 means described supra but have the added advantage of being able to accommodate variations in vertical positionings of the threaded openings 22 of an upper hub 17 of a spring compressor 3.

The means of rigidly securing the adaptor 1 to an upper hub 17 of a spring compressor 3 may be adapted to accommodate various upper hub 17 designs.

The adaptor 1 is manufactured of a material of sufficient strength for its purpose, preferably metal, more preferably steel.

FIGS. 1 and 6 show the adaptor 1 when used in combination with a non-motorized strut compressor 3 and a motorized unit of a portable electric pipe threader 2 to enable the motorization of the strut compressor 3. In the embodiment shown in these two figures the adaptor 1 is rigidly secured to an upper hub 17 of a spring compressor 3 by bolts 16 fed through the openings 13 in the lower portion 7 of the adapter and subsequently tightened within the threaded openings 22 in an upper hub 17 of the spring compressor 3. The threaded shaft 15 of the strut compressor 3 passes through the opening 11 in the upper portion 6 of the adaptor 1. An anti-rotation stem 19 is rigidly secured to the upper portion 20 of the spring compressor 3. A portable electric pipe threader motor assembly 18 is rigidly secured to the anti-rotation stem 19 in this embodiment by means of a bolt 18 fed through an opening 21 in the electric pipe threader 2 and subsequently threaded into the anti-rotation stem 19 and tightened. The electric pipe threader 2 is also rigidly secured to the upper portion 6 of the adapter 1 by a die holder 10 of the pipe threader 2. The upper portion 6 of the adapter 1 has a shape 9 enabling the die holder 10 to be rigidly secured to it.

This combination just described supra enables a method of compressing a spring in a motorized manner using an otherwise non-motorized strut compressor 3. FIG. 1 shows a spring 4 loaded into a strut compressor 3. This spring 4 may then be compressed by operating the electric pipe threader 2 to turn the mechanical adaptor 1 and thereby lower a threaded shaft 15 of the strut compressor 3 that then drives the compression of the spring 4. The spring 4 may be subsequently released by reversing the electric pipe threader 2 to raise the threaded shaft 15 of the strut compressor 3. It is desirable to compress strut springs 4 using this method because it enables the assembling and disassembling of a strut assembly of the type having a shock absorber 5 axially disposed within a coil spring 4.

It is within the scope of the present invention to tool or otherwise manufacture an upper hub 17 of a strut spring compressor 3 such that a motorized unit 2 of an electric pipe threader might be rigidly mounted directly thereto by means of a die holder 10. This would obviate the need for the adaptors 1 described supra. The upper hub 17 itself may be tooled or manufactured to have an outer surface (not shown) having the octagonal shape 9 or otherwise appropriate shape to enable a die holder 10 of an electric pipe threader 2 to be rigidly mounted thereto to avoid any need for an adaptor 1 to accomplish this rigid mounting. In this embodiment of the invention a strut spring compressor 3 may be motorized by using a motorized unit of an electric pipe threader 2 in combination with a strut spring compressor 3. This combination is constructed by rigidly securing a motorized unit 2 of an electric pipe threader to an appropriately shaped (not shown) upper hub 17 of a spring compressor 3 and by further rigidly mounting the motorized unit 2 to an upper surface 20 of the spring compressor 3 by means of an anti-rotation stem 19. The anti-rotation stem 19 is rigidly secured to the upper surface 20 of the spring compressor 3. The electric pipe threader 2 is rigidly secured to the anti-rotation stem 19 by means of a bolt 18 fed through an opening 21 in the electric pipe threader 2 and subsequently threaded into the anti-rotation stem 19 and tightened.

The combination described immediately supra enables a method of compressing a spring 4 in a motorized manner using an otherwise non-motorized strut compressor 3. FIG. 1 shows a spring 4 loaded into a strut compressor 3. This spring 4 may be compressed using the combination described immediately supra by operating the electric pipe threader 2 to turn the upper hub 17 and thereby lower a threaded shaft 15 of the strut compressor 3 that then drives the compression of the spring 4. The spring 4 may be subsequently released by reversing the electric pipe threader 2 to raise the threaded shaft 15 of the strut compressor 3. It is desirable to compress strut springs 4 using this method because it enables the assembling and disassembling of a strut assembly of the type having a shock absorber 5 axially disposed within a coil spring 4.

What is claimed is:

1. A mechanical adaptor for compressing springs with a strut spring compressor using a portable electric pipe threader motor assembly, said mechanical adaptor comprising:
a. a metal unitary hub with a top portion and a bottom portion, each having a vertical centered axis;
b. said top portion having an outside surface configured to fit a die holder of a motorized unit of a portable electric pipe threader, said top portion having an opening through said centered vertical axis;
c. said bottom portion having an opening aligned with said top portion opening;
d. means to rigidly mount onto an upper hub of said strut compressor.

2. The mechanical adaptor of claim 1 wherein said rigid mounting means comprises horizontal openings along a perimeter of said bottom portion.

3. The mechanical adaptor of claim 1 wherein said rigid mounting means comprises vertical slots in said bottom portion surface.

4. A motorized strut spring compressor, said compressor comprising in combination:
a. a strut spring compressor;
b. a mechanical adaptor as claimed in claim 1 rigidly mounted to said upper hub of said strut spring compressor;
c. a motorized unit of a portable electric pipe threader rigidly mounted to said strut spring compressor by an anti-rotation stem and rigidly secured to said mechanical adaptor by a die holder of said pipe threader.

5. A method of compressing a spring, said method comprising:
a. providing said motorized strut spring compressor as claimed in claim 2;
b. installing a spring into said motorized strut compressor;
c. compressing said spring by operating said electric pipe threader to turn said mechanical adaptor thereby lowering a threaded shaft of said strut compressor;
d. releasing said spring by reversing said electric pipe threader to turn said rigidly mounted adaptor to raise said threaded shaft of said strut compressor.

6. A motorized strut spring compressor, said spring compressor comprising in combination:
a. a motorized unit of a portable electric pipe threader and a non-mechanized strut spring compressor wherein said motorized unit is rigidly mounted to said spring compressor by an anti-rotation stem and also rigidly mounted to an upper hub of said spring compressor by a die holder of said motorized unit, said upper hub having an appropriate shape for said motorized unit to mount thereto by the die holder of said unit.

7. A method of compressing a spring, said method comprising:
a. providing said motorized strut spring compressor as claimed in claim 6;
b. installing a spring into said motorized strut compressor;
c. compressing said spring by operating said electric pipe threader to turn said upper hub thereby lowering a threaded shaft of said strut compressor;
d. releasing said spring by reversing said electric pipe threader to turn said rigidly mounted adaptor to raise said threaded shaft of said strut compressor.
